(19) United States
(12) Patent Application Publication
(10) Pub. No.: US 2013/0063230 A1
(43) Pub. Date: Mar. 14, 2013

(54) BROAD-BAND COUPLING TRANSDUCERS FOR WAVEGUIDES

(71) Applicants: Richard R. A. Syms, Ealing (GB); Ian R. Young, Marlborough (GB); Laszlo Solymar, Oxford (GB)

(72) Inventors: Richard R. A. Syms, Ealing (GB); Ian R. Young, Marlborough (GB); Laszlo Solymar, Oxford (GB)

(21) Appl. No.: 13/636,373

(22) PCT Filed: Mar. 22, 2011
(86) PCT No.: PCT/GB2011/050571

§ 371 Date: Nov. 26, 2012

(30) Foreign Application Priority Data
Mar. 23, 2010 (GB) 1004838.7

(51) Int. Cl. H01P 5/04

(52) U.S. Cl. 333/24 R; 29/600

(57) ABSTRACT

A method of producing a waveguide and a coupling transducer for connecting the waveguide to a load is disclosed. The method comprises: forming a series of similar circuits each circuit comprising two capacitors and at least one inductor section, the circuits being coupled to together to form the waveguide; and removing one of the capacitors and at least part of the at least one inductor section from one of the circuits to form the coupling transducer.

### FIELD OF THE INVENTION

The present invention relates to coupling transducers for coupling waveguides to other electrical systems. It has particular application in the connection of magneto-inductive waveguides to conventional transmission lines.

### BACKGROUND TO THE INVENTION

Magneto-inductive (MI) waveguides are periodic low-frequency electrical structures, formed by magnetically coupling a set of lumped-element L-C circuits. The properties of linear arrangements and 2D and 3D MI arrays have been extensively studied, together with those of variants known as metasolenoids. Propagation losses have been reduced, and the effects of non-nearest neighbour interactions, bi-periodicity, coupling to electromagnetic waves and retardation have all been considered. Although the first demonstrations used simple resonant loops, MI waveguides have also been formed as planar structures [Freire M. J., Marques R., Medina F., Laso M. A. G., Martin F. “Planar magneto-inductive wave transducers: Theory and applications” Appl. Phys. Letts. 85, 4439-4441 (2004)] and thin-film cables [Syms R. R. A., Young I. R., Solymar L., Floume T. “Thin-film magneto-inductive waveguides” J. Phys. D. Appl. Phys. 43, 055102 (2010)]

The latter have potential applications as patient-safe cable in magnetic resonance imaging. Many magneto-inductive devices have been proposed or demonstrated, including magnetic flux concentrators, delay lines, filters, directional couplers, passive splitters, lenses for near-field imaging and detectors for magnetic resonance imaging. Parametric amplification has been considered as a method of reducing propagation losses.

Despite this effort, losses per metre have historically been high (of the order of 50 to 150 dB/m, propagation distances have been limited, and end-reflections have mainly been ignored. However, the demonstration of losses of about 2.5 dB/m in thin-film cables [Syms R. R. A., Young I. R., Solymar L., Floume T. “Thin-film magneto-inductive waveguides” J. Phys. D. Appl. Phys. 43, 055102 (2010)] has re-affirmed the need for an effective transducer for coupling to conventional transmission line or for termination. Although multi-element absorbers have been proposed [Syms R. R. A., Solymar L., Shamonina E. “Absorbing terminations for magnetoinductive waveguides” IEE Proc. Micr. Antennas Propag. 152, 77-81 (2005)], these do not solve the coupling problem.

### SUMMARY OF THE INVENTION

The present invention provides a method of producing a waveguide and a coupling transducer for connecting the waveguide to a real load. The method comprises forming a series of similar circuits, the circuits being coupled to together to form the waveguide. Each circuit may comprise two capacitors and at least one inductor section. The method may comprise removing one of the capacitors and/or at least part of the at least one inductor section from one of the circuits to form the coupling transducer.

The waveguide circuits may be coupled to each other by mutual inductance. In some embodiments this may be the only coupling between the circuits.

The at least one inductor section may comprise two inductor sections. The step of removing at least part of the at least one inductor section may comprise removing one of the inductor sections. The inductor sections may have substantially the same inductance as each other. Alternatively the at least one inductor section can comprise one continuous inductor section, a part of which is removed.

The capacitors may have substantially the same capacitance as each other.

The circuits may be formed on a substrate. The step of removing one of the capacitors and at least part of the at least one inductor section may comprise cutting the substrate. The two capacitors may be offset from each other along the length of the substrate so that one of the capacitors can be removed by making a straight-line cut across the substrate.

Each of the circuits of the waveguide may be tuned to a resonant frequency and the coupling transducer may be tuned to substantially the same resonant frequency.

The circuits and the transducer may be arranged such that, when a load of a predetermined real impedance is connected to the transducer and a signal transmitted along the waveguide to the load, the reflectance of the signal at the transducer will have minima, or nulls, at at least two frequencies of the signal.

The present invention further provides a waveguide and coupling transducer assembly, wherein the waveguide comprises a plurality of circuits coupled to each other to form the waveguide, each of the circuits having the same structure as the others, and the coupling transducer has a structure which is the same as part of one of the waveguide circuits.

The assembly may comprise a substrate, with the waveguide and coupling transducer formed on at least one surface of the substrate.

Each waveguide circuit may comprise two capacitors and two inductors.

The coupling transducer may comprise a capacitor having the same structure as one of the two capacitors. The coupling transducer may comprise an inductor having the same structure as one of the inductors.

The two capacitors of each waveguide circuit may have the same structure as each other. The two inductors of each waveguide circuit may have the same structure as each other.

The present invention further provides a method of connecting a waveguide to a real load using a coupling transducer, the method comprising: providing a waveguide comprising a plurality of circuits each having an inductance and a capacitance, the circuits being coupled together to form the waveguide that can transmit at frequencies within a propagating band; providing a coupling transducer connected to the waveguide and also having a capacitance and an inductance; and connecting a real load to the coupling transducer. The capacitances and inductances and the load may be chosen such that the reflectance at the transducer of waves propagated along the waveguide towards the load has two minima, or nulls, within the propagating band.

The present invention further provides a waveguide and coupling transducer assembly for connection to a load of a predetermined real impedance, the waveguide comprising a plurality of circuits each having an inductance and a capacitance, the circuits being coupled together to form the waveguide that can transmit at frequencies within a propagating band, and the coupling transducer also having a capacitance and an inductance and being arranged to be connected to the load. The capacitances and inductances are chosen such that the reflectance at the transducer of waves propagated along the waveguide towards the coupling transducer, when the load is connected, will have two minima, or nulls, within the propagating band.

The waveguide circuits may have a resonant frequency and the coupling transducer may have a resonant frequency substantially equal to that of the waveguide circuits. The coupling transducer may have the same structure as a part of one of the waveguide circuits.

Some embodiments of the present invention can therefore provide transducers for inductive coupling to a MI waveguide, including a simple broadband transducer that can be constructed from passive components.

Preferred embodiments of the present invention will now be described by way of example only with reference to the accompanying drawings.

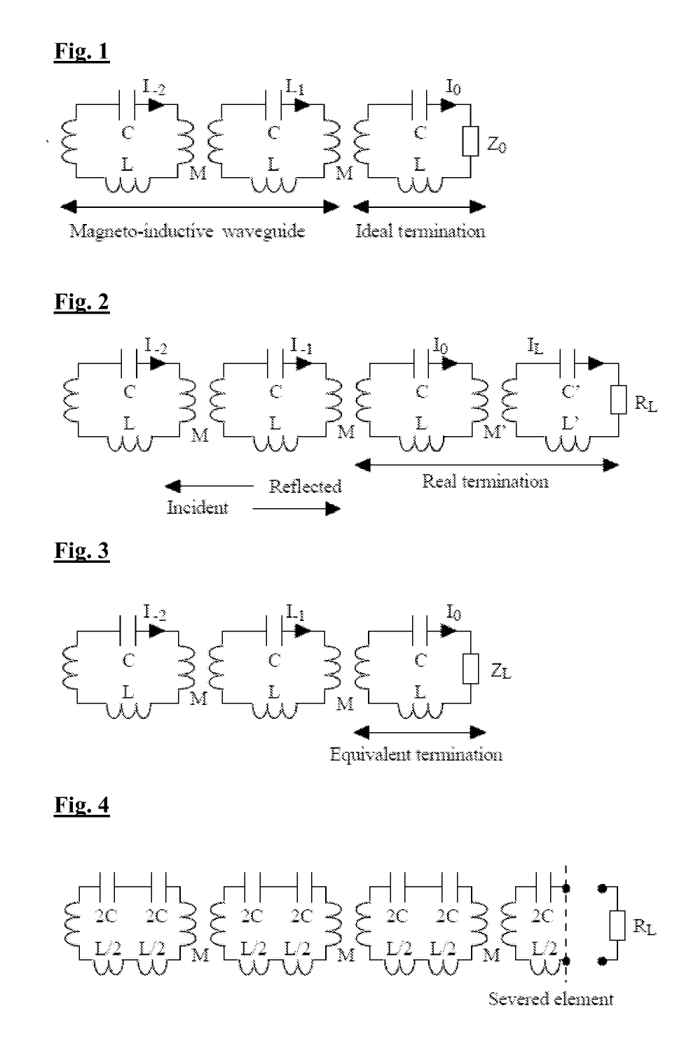

FIG. 1 is a diagram of a magneto-inductive waveguide with ideal termination;

FIG. 2 is a diagram of a magneto-inductive waveguide with real termination;

FIG. 3 is a diagram of a magneto-inductive waveguide with a termination equivalent to that of FIG. 2;

FIG. 4 is a diagram of a magneto-inductive waveguide with self-termination;

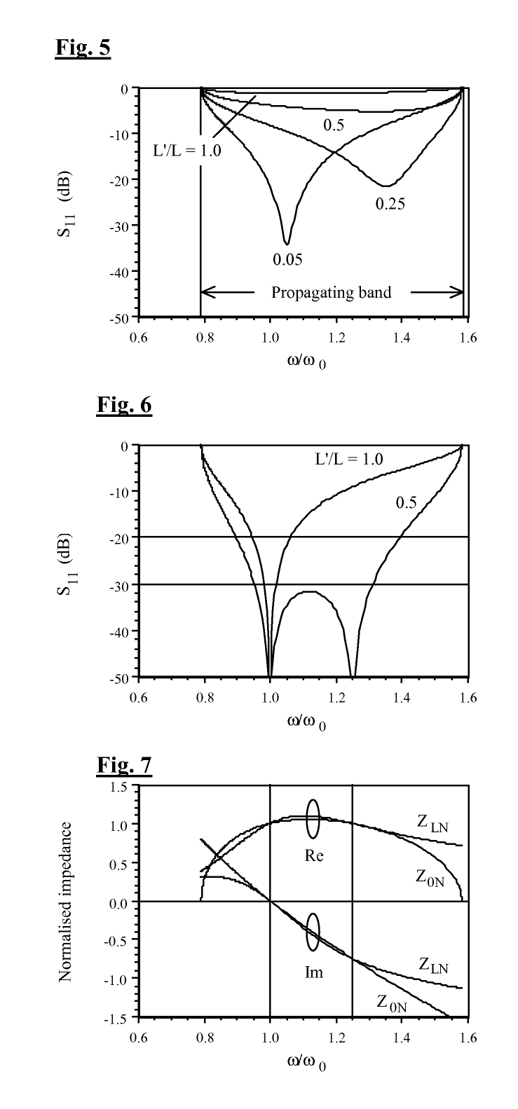

FIG. 5 is a graph of frequency variation of the scattering parameter S₁₁ for non-resonant transducers calculated assuming M′=M, κ=0.6 and different values of L′/L;

FIG. 6 is a graph of frequency variation of the scattering parameter S₁₁ for resonant transducers, calculated assuming M′=M, κ=0.6, ω₀′=ω₀ and different values of L′/L;

FIG. 7 is a graph of frequency variation of the real and imaginary parts of the normalised impedances Z₀/ωM and Z_{τ}/ωM, calculated assuming M′=M, κ=0.6, ω₀′=ω₀ and L′=L/2;

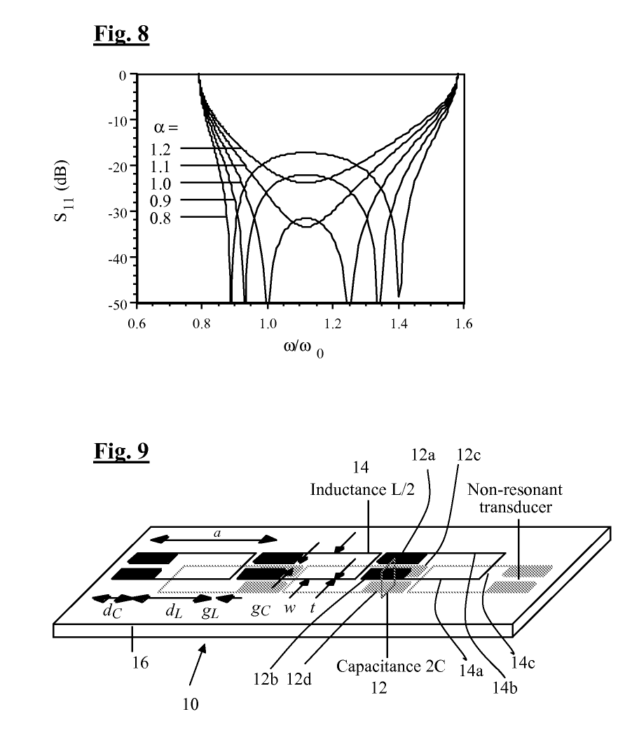

FIG. 8 is a graph of frequency variation of the scattering parameter S₁₁ for resonant transducers, calculated assuming M′=M, κ=0.6, L′/L=0.5 and different values of α;

FIG. 9 is a perspective new of a thin-film magneto-inductive cable according to an embodiment of the invention;

FIG. 10 is a graph showing frequency variation of S₁₁ and S₂₁ for thin-film magneto-inductive cable, with non-resonant transducers. Points are experimental data, lines are theory; and

FIG. 11 is a graph showing frequency variation of S₁₁ and S₂₁ for thin-film magneto-inductive cable, with resonant transducers. Points are experimental data, lines are theory.

### MATCHING TO MAGNETO-INDUCTIVE WAVEGUIDES

We first consider the principle of matching a magneto-inductive waveguide to a real load. FIG. 1 shows the equivalent circuit of an ideal, loss-less guide, formed from a set of L-C resonators coupled to their nearest neighbours by a mutual inductance M. Away from any termination (n<0) the equation governing the current Iₙ in the nth element at angular frequency ω can be found from Kirchhoff's current law:

{jωL+1/jωC+R}Iₙ+jωM{Iₙ₋₁+Iₙ₊₁}=0 (1)

A solution can be found by assuming that Iₙ is the travelling wave Iₙ=T₀ exp(±jnka), where I₀ is the wave amplitude, ka is the phase shift per element, k is the propagation constant and a is the period. Substitution into Equation 1 yields the well-known dispersion equation:

(1−ω₀²/ω²)+κcos(ka)=0 (2)

Here ω₀²=1/LC is the angular resonant frequency and κ=2M/L the coupling coefficient. For positive κ, propagation can only take place for ω/ω₀ between 1/√(1+κ) and 1/√(1−κ).

It has been shown that a non-reflective termination is formed by inserting an impedance Z₀ into the last (referred to herein as the 0^{th}) element of the waveguide, where Z₀ is given by:

Z₀=jωMexp(−jka) (3)

At mid-band, when ω=ω₀ and ka=π/2, Z₀ reduces to the real value Z_{0M}=ω₀M. Thus, in principle it should be possible to couple a magneto-inductive waveguide to a conventional transmission line (which has real impedance) if M is appropriately chosen. Unfortunately, Z₀ is complex away from the band centre, and moreover as expressed here is a function of both ka and ω. Consequently, Equation 3 has so far represented a mathematical contrivance, rather than an element that can be realised. Further development of MI systems clearly requires simple circuits that can approximate this impedance.

In order to describe transducers according to some embodiments of the invention we consider the termination in FIG. 2. Here the final element of a MI waveguide, is coupled via a mutual inductance M′ to a loop containing an inductance L′, a capacitance C′ and a real load R_{L}, which will typically represent a 50Ω system. The loop is resonant at an angular frequency ω₀′=1/L′C′, but may be considered non-resonant when ω₀′ is zero. For the final elements, the circuit equations are:

{jωL+1/jωC}I₀+jωMI₋₁+jωM′I_{L}=0

{R_{L}+j(ωL′−1/WC′)}I_{L}+jωM′I₀=0 (4)

Combining Equations 4, we obtain for the 0^{th} element:

{jωL+1/jωC+Z_{L}}I₀+jωMI₋₁=0 (5)

Here Z_{L} is a load that has effectively been inserted into the 0^{th} element, given by:

Z_{L}=ω²M′²/{R_{L}+jωL′(1−ω₀′²/ω²)} (6)

We may evaluate the performance of Z_{L} as a termination by considering the reflection of current waves as shown in FIG. 3. Assuming solutions of Equations 1 and 5 as the sum of incident and reflected waves, i.e. as Iₙ=I_{I}exp(−jnka)+I_{R}exp(+jka), substituting into Equation 5 and using Equation 2 we can obtain the reflection coefficient Γ=I_{R}/I_{I} as:

Γ=−{Z_{L}−Z₀}/{Z_{L}+Z₀*} (7)

Equation 7 is similar to the reflection coefficient for current waves obtained when a conventional transmission line is terminated with a load. However, due to the presence of a complex conjugate term Z₀*, it is clearly not identical.

Since the current in element zero, which passes through the effective load Z_{L}, is I₀=I_{I}+I_{R}, we can also define a transmission coefficient as T=I₀/I_{I}=(1+Γ), or:

T=2Re(Z₀)/{Z_{L}+Z₀*} (8)

Equation 8 is again similar, but not identical to the conventional transmission coefficient, due to the presence of a real operator. It is simple to show that Γ and T satisfy the power conservation relation:

ΓΓ*+TT*Re(Z_{L})/Re(Z₀)=1 (9)

Once again, Equation 9 is similar to the corresponding result for real-valued systems.

Different terminations can be compared by plotting the scattering parameter S₁₁ which is a measure of reflection expressed in dB, as:

S₁₁≈10 log₁₀{|Γ|²} (10)

Equation 7 implies that Z, should be chosen to approximate Z₀ as far as possible. We now compare a number of possibilities, assuming for simplicity that Z_{0M}=R, and that M′=M.

FIG. 5 shows the frequency variation of S₁₁ obtained in a non-resonant transducer for different values of L′/L, calculated assuming the typical coupling coefficient κ=0.6. Propagation can take place over the band 0.79≦ω/ω₀≦1.58, and S₁₁ rises to 0 dB at the band edges. Within the band, S₁₁ reduces somewhat. However, when L′/L=1, the reflection coefficient is generally high and the transducer is correspondingly ineffective. As L′/L reduces, a deeper and deeper minimum in S₁₁ develops, and gradually shifts towards ω/ω₀=1. These results imply that the performance of the transducer improves as L′/L reduces, and that the best result is obtained when only a small reactance is inserted into the final loop. However, the best that can be achieved still only represents a narrow-band impedance match. Furthermore, the minimum in S₁₁ is relatively high (−35 dB), and even this result is only obtained for very small values of L′/L, when it may be difficult to maintain M′/M=1.

The inserted reactance can clearly be cancelled more effectively if the transducer is made resonant. FIG. 3 shows the corresponding variation of S₁₁ obtained for a resonant transducer, calculated assuming that κ=0.6 and that L′ and C′ are chosen so that ω₀′=ω₀. Results are again shown for different values of L′/L. The most obvious choice of L′/L=1 provides a complete null in reflectivity when ω/ω₀=1. However, this result again only represents a narrow-band match. In contrast, the less obvious choice of L′/L=0.5 provides two nulls in reflectivity, the first again being at ω/ω₀=1. Because the nulls are widely separated, low reflectivity is obtained over a wide band. For example, S₁₁ is less than −20 dB for 65% of the pass-band, and less than −30 dB for 45%. This form of transducer is extremely effective. Importantly, it can be realised very conveniently as shown in FIG. 4. Here each resonant element in a MI waveguide is now formed from an identical loop having, in series in the loop, two separate inductors, each of value L/2, and two capacitors of value 2C. If half the final element is simply removed, the remainder may then be connected, at the two points where it was cut, directly to a resistive load R_{L}. This modification allows MI waveguides of arbitrary length to be terminated without the need for additional components.

### TRANSDUCER OPTIMISATION

We now consider the broadband resonant transducer of FIG. 4 in more detail. To understand how it achieves its effect, we introduce the normalised characteristic impedance Z_{0N}=Z₀/ω₀M, obtained from Equation 3 as:

Z_{0N}=w/{sin(ka)−jcos(ka)} (11)

Here w=ω/ω₀ is a normalised frequency. Using the dispersion equation (2), Z_{0N} may be written alternatively as:

Z_{0N}=w/{√[1−(1−1/w²)²/κ²]+j(1−1/w²/κ} (12)

In this form, Z_{0N} is clearly a function only of w. Consequently it may be compared directly with the corresponding normalised load impedance Z_{LN}/ω₀M, which may be written as:

Z_{LN}=w/{ρ/wμ²+j(2λ/κμ²)(1−η²/w²)} (13)

Here we have introduced four normalised variables. The first, ρ=R_{L}/ω₀M, is the ratio of the R_{L} to the mid-band impedance of the MI waveguide. The second, λ=L′/L, is the ratio of the self-inductances in the transducer and the guide, the third, μ=M′/M, is the ratio of mutual inductances, and the fourth, η=ω₀′/ω₀, is the ratio of resonant frequencies.

Clearly, reflectivity will be low if the real and imaginary parts of Z_{0N} and Z_{LN} are similar, or alternatively if the real and imaginary parts of the normalised admittances Y_{0N}=1/Z_{0N} and Y_{LN}=1/Z_{LN} correspond. Considering first the imaginary parts, Im(Y_{0N}) can be made equal to Im(Y_{LN}) for all ω if η=1 and λ=μ²/2. If μ=1, as previously assumed, a complete match in admittance can therefore be obtained if the transducer is resonant at ω₀ and the inductance L′ of the transducer is half that of the resonant elements forming the guide.

Considering now the real parts, and assuming that the transducer is correctly resonant, Re(Y_{0N}) can be made equal to Re(Y_{LN}) if:

ρ/wμ²=√[1−(1−1/w²)²/κ²] (14)

Equation 14 is actually a quadratic equation, which can be expanded as:

w⁴{κ²−1}+w²{2−α²κ²}−1=0 (15)

Here, α=ρ/μ². When α=1, a condition that can be achieved by taking M′=M and ω₀M=R_{L}, Equation 15 has the simple solutions of w=1 and w=1/√(1−κ²). Both lie in the propagating band. These results imply that if ω₀M=R_{L}, and if the transducer is made resonant at ω₀ using an inductance L′=L/2 (which requires a capacitance C′=2C), the imaginary parts of Y_{L} and Y₀ can be made equal across the band and the real parts at two discrete frequencies. Consequently, Z₀ and Z_{L} can be equalised at the same two frequencies, and at these points there can be no reflection. These results are confirmed in FIG. 4, which shows the frequency variations of the real and imaginary parts of Z_{0N} and Z_{LN}, calculated assuming κ=0.6. Matching is achieved when w=ω/ω₀=1 and ω/ω₀=1/√(1−0.6²)=1.25, the points at which nulls in reflectivity are seen in FIG. 3. Broadband operation then follows from the existence of these two separate nulls.

A broadband transducer can still be constructed if α≠1 (for example, if M′=M but ω₀M≠R_{L}. FIG. 5 shows the frequency variation of the scattering parameter S₁₁ for resonant transducers, calculated assuming κ=0.6, and L′/L=0.5 and assuming different values of α. For α<1, there are again two nulls in reflectivity, which move further apart as α reduces. For α>1, there is only a single minimum, not a null. However, in each of the cases shown, the return is generally low over a wide spectral range. These results suggest that the broadband resonant transducer will give reasonable performance even when the mid-band impedance of the MI waveguide is slightly mismatched from R_{L}.

It will therefore be appreciated that, any similar waveguide and coupling transducer combination will generally function over a broad range of frequencies provide the capacitances and inductances of the waveguide circuit elements and the load are chosen so that equation 15 has two solutions within the propagating band of the waveguide.

Finally, it is simple to show that the two nulls in reflectivity just merge together when the roots of Equation 15 are repeated. This occurs when

(2−α²κ²)²=4(1−κ²) (16)

Or when:

α⁴κ²−4α²+4=0 (17)

Equation 17 has the solutions α=(√2/Λ){1±√(1−Λ²)]}^{1/2}. For κ=0.6, for example, the solutions are α=3.162 and α=1.054. The latter value is midway between α=1 and α=1.1, and generates a variation in reflectivity with a single null.

### EXPERIMENTAL VERIFICATION

Experimental confirmation of the theory of the previous section was provided using thin-film magneto-inductive cables formed by double-sided patterning of copper-clad polyimide as shown in FIG. 6. Here a thin film magneto-inductive waveguide 8 is formed from a series of identical resonant elements 10, each of which comprises two capacitors 12 and two inductors 14. The waveguide comprises a strip of flexible substrate 16 with the capacitors 12 and inductors 14 formed on the surface of the substrate. Each element 10 is formed from two rectangular capacitor plate regions 12a 12b side by side on one side of the substrate 16, and two capacitor plate regions 12c 12d formed on the other side of the substrate 16 and aligned with those on the first side to form the two capacitors 12, all of the capacitor plates 12a, 12b, 12c, 12d being the same size. Each adjacent pair of capacitor plates is connected together by a three-sided inductive loop 14 comprising two parallel track sections 14a, 14b extending along the strip, each having one end connected to a respective one of the plates 12a, 12b, and the other end connected to a transverse track section 14c. The two loops 14 of each element extend in opposite directions away from the capacitors 12 along the substrate 16. Each of the inductive loops 14 is aligned with, but on the opposite side of the substrate 16 to, an inductive loop 14 of an adjacent element, to provide mutual inductance between the elements. The inductors 14 are therefore single-turn loops of inductance L/2, located on either side of the thin substrate, while the capacitors are parallel-plate components of capacitance 2C, which use the substrate as a dielectric interlayer.

This arrangement therefore approximates that of FIG. 4, although it does not allow a resonant termination to be formed by cutting straight across the cable. Instead, it provides a non-resonant termination formed from the end half-element of inductance L′=L/2 and nominally zero capacitance, which may be made resonant with additional capacitors. Since the mutual inductances M and M′ are the same, this arrangement has normalised parameter values λ=0.5 and μ=1.

Cables were fabricated in two metre lengths. The substrate base material consisted of 25 μm thick Kapton® carrying a 35 μm thick layer of copper on either side. The copper was patterned by step-and-repeat lithographic exposure to a pair of one metre long photomasks, followed by wet etching. The photomasks contained a set of MI waveguides with different parameters. The overall width and length were taken as w=4.7 mm and a=100 mm throughout, so that a two-metre length contained 19 resonant elements. The track width t, and the small gaps g_{c} and g_{L} between capacitor plates and between plates and tracks were all taken as 0.5 mm. The main variables were the capacitor and inductor lengths d_{c} and d_{L}, which were varied to obtain different properties. Of particular importance were the inductance L, the capacitance C, the mutual inductance M, and the Q-factor of the resonant elements (which has not been discussed above). These parameters determine the resonant frequency f₀=ω₀/2π, the coupling coefficient κ=2M/L, the mid-band impedance Z_{0M}=ω₀M and an imaginary part of the propagation constant.

The last quantity may be modelled by repeating the analysis of an infinite MI waveguide, assuming the presence of a resistor R in each resonant loop. If this is done, the dispersion equation is modified to

(1−Φ₀²/ω²−j/Q)+κcos(ka)=0, (18)

where Q=ωL/R is the Q-factor. Assuming a complex-valued propagation constant ka=k′a−jk″a, and further assuming that k″a is small, it can be shown that k″a=1/{κQ sin (k′a)}. Losses are lowest at mid-band, and strong coupling and a high Q-factor are required for low loss.

Electrical performance was evaluated using an Electronic Network Analyser (ENA). The inductance was determined by making the transducers resonant at low frequency with a known capacitor and measuring the resonant frequency with a weak inductive probe. The remaining parameters were estimated by attaching SMA-type end-launch connectors, measuring transmission and reflection data, and fitting the data to a theoretical model. The smallest reflections were obtained with the MI waveguide held straight, using an additional co-axial cable to return the transmitted signal to the ENA.

The theoretical model includes propagation loss but ignores multiple reflections. In this case, the scattering parameters S₁₁ and S₂₁ for an N-element MI waveguide connected to a source with real output impedance R_{L} and a similar load are given approximately by:

S₁₁≈10log₁₀{|Γ|²} (19)

S₂₁≈10log₁₀{(1−|Γ|²)exp(−2Nk″a)(1−|Γ|²)} (20)

FIG. 7 shows a comparison between experimental measurement of the frequency variations of S₁₁ and S₂₁ and the theory above, for a cable with d_{c}=10 mm and d_{L}≈90 mm. The experimental data show band-limited propagation between 70 MHz and 160 MHz. Overall transmission is high, and S₂₁ peaks at −8 dB near 110 MHz. Oscillations in transmission and reflection are due to multiple reflections, and suggest low propagation loss. However, the return is high, and the minimum value of S₁₁ is only ≈−7 dB. These results confirm the poor performance of non-resonant transducers. The agreement between theory and experiment is clearly good, apart from the inability of the former to model multiple reflections and a small discrepancy in S₂₁ at high frequency.

The combination of direct measurement and matching to theory allowed deduction of the following parameter values. The inductance was estimated as L=241 nH, the resonant frequency as f₀=95 MHz, the capacitance as C=11.6 pF, the coupling coefficient as κ=0.675, the mid-band impedance as Z_{0M}=48.6Ω. and the Q-factor as Q=48 (which in turn implies a mid-band propagation loss of 0.27 dB/m). The mid-band impedance is clearly close to 50Ω, and gives a value of ρ=R_{L}/Z₀M=1.028.

The terminations were made resonant using surface mount capacitors, using the optimum capacitance value of twice the measured capacitance of each of the capacitors (2×11.6≈23 pF). Electrical performance was then re-measured to give the results shown in FIG. 8. Here, peak transmission has now increased to −5.2 dB, and the oscillations due to multiple reflections have largely disappeared. The return has significantly reduced, and S₁₁ is below −25 dB for much of the band. The data are again compared with theory, this time assuming a resonant termination, and good agreement is again obtained. However, the predicted nulls in reflection cannot be seen in the experiment, presumably due to other small reflections from connections. These results confirm the improvement in performance offered by the optimum resonant termination.

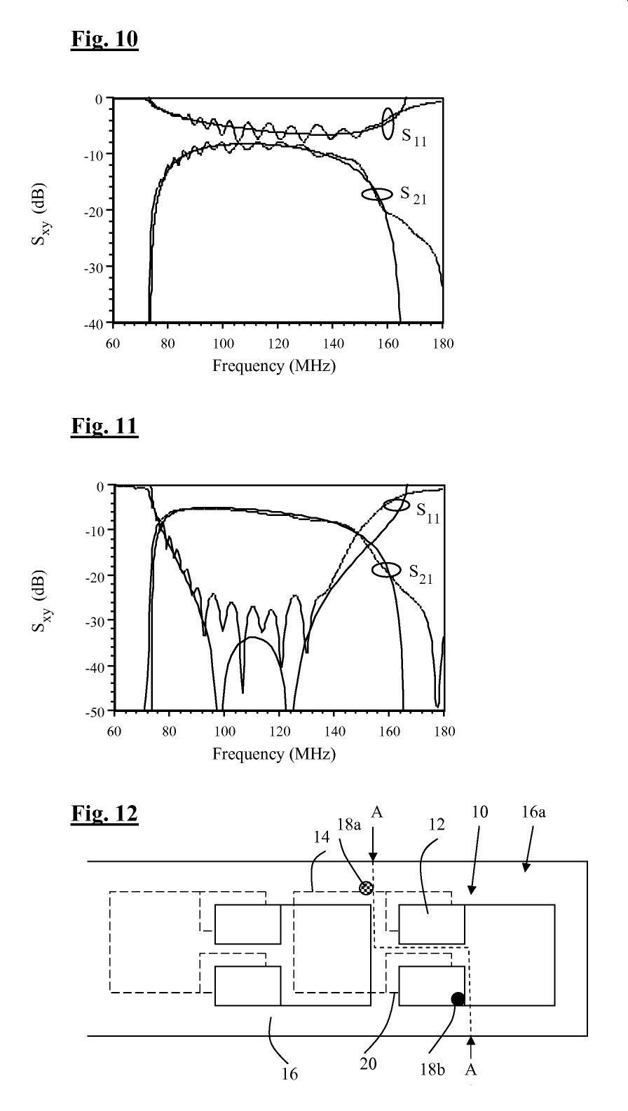

Referring to FIG. 12, the waveguide 8 of FIG. 6 could in theory be cut along the line A-A so that half of the resonant element 10 at the end of the waveguide forms a resonant transducer coupling corresponding to that of FIG. 4. Specifically, if the waveguide 8 is cut so that one of the capacitors 12 of the end resonant element 10 remains in place, and the other is removed, and also so that one of the inductive loops 14 remains in place, and coupled to the second element on the waveguide, and the other inductive loop removed, then a resonant coupling transducer 20 is produced. This transducer 20 comprises one inductive loop 14 and one capacitor plate 12a on one side of the substrate, and one capacitor plate 12c on the other side of the substrate to form a complete capacitor. This allows a load to be connected between to connection points, one 18a at the free end of the inductive loop 14 and one 18b on the capacitor plate 12c on the opposite side of the substrate.

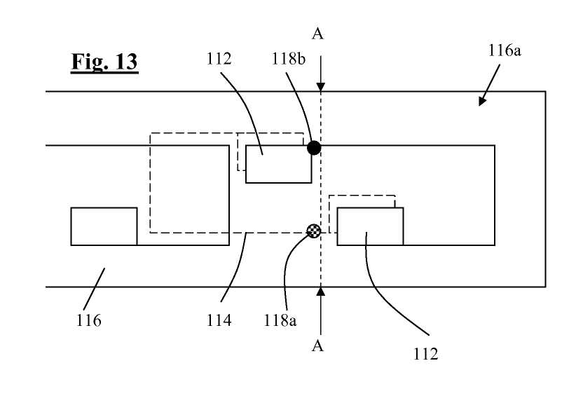

Referring to FIG. 13, in a further embodiment of the invention, the waveguide 108 is similar to that of FIG. 6, but with the two capacitors 112 of each resonant element offset from each other along the length of the strip by more than the length of the capacitor plates, so that they do not overlap, and are spaced apart, in the longitudinal direction along the strip. This results in each of the inductive loops 114 having two parallel track sections of different lengths. This allows the waveguide to be cut transversely in a straight line between the two capacitors 112 of one of the resonant loops, leaving connection points at the free end of the cut strip, one on each side, again with one 118a at the free end of the inductive loop 114 of the cut element and one 118b on the capacitor plate 12c on the opposite side of the substrate 116.

A simple inductive transducer for coupling a magneto-inductive waveguide to a real load has been introduced. A theory of reflection from lumped-element coupling transducers has been developed. It has been shown that zero reflection can be obtained at a single frequency if the (real-valued) mid-band impedance of the MI waveguide matches the load, and if the transducer is resonant at the same frequency as the resonant elements forming the guide. If in addition the inductance of the transducer is half that used in the resonant elements and the capacitance is correspondingly double, matching to the load can also be achieved at a second frequency. Since zero reflection is now obtained at two separate frequencies, low reflectivity can be obtained over a broad spectral range. The theory has been compared with experimental results obtained from thin-film magneto-inductive cable. Excellent agreement has been obtained, and the improvement in performance offered by the optimised resonant transducer has been confirmed by comparison with a non-resonant equivalent.

Other more complicated transducer designs can doubtless be developed to achieve improved broadband performance. However, the simple design presented here has the important advantage that a transducer with exactly the required properties can be obtained from the waveguide itself, if the resonant elements are formed using pairs of inductors and capacitors in series, rather than single components. As a result, a connection between a MI waveguide and a real load may be obtained simply by splicing.

1-17. (canceled)

18. A method of producing a waveguide and a coupling transducer for connecting the waveguide to a load, the method comprising: forming a series of similar circuits each circuit comprising two capacitors and at least one inductor section, the circuits being coupled to together to form the waveguide; and removing one of the capacitors and at least part of the at least one inductor section from one of the circuits to form the coupling transducer.

19. The method according to claim 18 wherein the at least one inductor section comprises two inductor sections, and the step of removing at least part of the at least one inductor section comprises removing one of the inductor sections.

20. The method according to claim 19 wherein the two inductor sections each have an inductance, and the inductances of the two inductor sections are substantially the same as each other.

21. The method according to claim 20 wherein the capacitors have substantially the same capacitance as each other.

22. The method according to claim 18 wherein the circuits are formed on a substrate, and the step of removing one of the capacitors and at least part of the inductor section comprises cutting the substrate.

23. The method according to claim 22 wherein the substrate has a length, and the two capacitors are offset from each other along the length of the substrate so that one of the capacitors can be removed by making a straight-line cut across the substrate.

24. The method according to claim 18 wherein each of the circuits is tuned to a resonant frequency and the coupling transducer is tuned to substantially the same resonant frequency.

25. The method according to claim 18 wherein the circuits and the transducer are arranged such that, when a load of a predetermined impedance is connected to the transducer and a signal transmitted along the waveguide to the load, the reflectance of the signal at the transducer will have minima at at least two frequencies of the signal.

26. A waveguide and coupling transducer assembly, wherein the waveguide comprises a plurality of circuits coupled to each other to form the waveguide, each of the circuits having the same structure, and the coupling transducer has a structure which is the same as part of one of the waveguide circuits.

27. The assembly according to claim 26 comprising a substrate having at least one surface, wherein the waveguide and coupling transducer are formed on the at least one surface of the substrate,

28. The assembly according to claim 26 wherein each waveguide circuit comprises two capacitors and two inductors, and the coupling transducer comprises a capacitor having the same structure as one of the two capacitors and an inductor having the same structure as one of the inductors.

29. The assembly according to claim 28 wherein the two capacitors of each waveguide circuit have the same structure as each other.

30. The assembly according to claim 28 wherein the two inductors of each waveguide circuit have the same structure as each other.

31. A method of connecting a waveguide to a load using a coupling transducer, the method comprising: providing a waveguide comprising a plurality of circuits each having an inductance and a capacitance, the circuits being coupled together to form the waveguide that can transmit at frequencies within a propagating band; providing a coupling transducer connected to the waveguide and also having a capacitance and an inductance; and connecting a load to the coupling transducer, wherein the capacitances and inductances and the load are chosen such that the reflectance at the transducer of waves propagated along the waveguide towards the load has two minima within the propagating band.

32. A waveguide and coupling transducer assembly for connection to a load of a predetermined impedance, the waveguide comprising a plurality of circuits each having an inductance and a capacitance, the circuits being coupled together to form the waveguide that can transmit at frequencies within a propagating band, and the coupling transducer also having a capacitance and an inductance and being arranged to be connected to the load, wherein the capacitances and inductances are chosen such that the reflectance at the transducer of waves propagated along the waveguide towards the coupling transducer, when the load is connected, will have two minima within the propagating band.

33. The assembly according to claim 32 wherein the waveguide circuits have a resonant frequency and the coupling transducer has a resonant frequency substantially equal to that of the waveguide circuits.

34. The assembly according to claim 32 wherein the coupling transducer has the same structure as a part of one of the waveguide circuits.
